(19) United States
(12) Patent Application Publication
(10) Pub. No.: US 2014/0202850 A1
(43) Pub. Date: Jul. 24, 2014

(54) PHOTOELECTRODE FOR SOLAR WATER OXIDATION

(71) Applicants: Coleman X. Kronawitter, Berkeley, CA (US); Samuel S. Mao, Castro Valley, CA (US)

(72) Inventors: Coleman X. Kronawitter, Berkeley, CA (US); Samuel S. Mao, Castro Valley, CA (US)

(73) Assignee: THE REGENTS OF THE UNIVERSITY OF CALIFORNIA, Oakland, CA (US)

(21) Appl. No.: 14/245,139

(22) Filed: Apr. 4, 2014

Related U.S. Application Data
(63) Continuation of application No. PCT/US2012/059551, filed on Oct. 10, 2012.
(60) Provisional application No. 61/546,513, filed on Oct. 12, 2011.

(51) Int. Cl. H01G 9/20; H01G 9/00

(52) U.S. Cl. CPC H01G 9/2027; H01G 9/0029
USPC 204/290.12; 438/57; 204/290.01

(57) ABSTRACT

This disclosure provides systems, methods, and apparatus related to photoelectrodes. In one aspect, a photoelectrode may include a substrate including an electrically conductive surface and at least one nanostructure in electrical contact with the surface of the substrate. The nanostructure may include an impurity. The impurity may impart a light-absorbing characteristic to the nanostructure.

### RELATED APPLICATIONS

This application is a continuation of PCT Application No. PCT/US2012/059551, filed Oct. 10, 2012, which claims priority to U.S. Provisional Patent Application No. 61/546,513, filed Oct. 12, 2011, both of which are herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### FIELD

Embodiments disclosed herein relate to the field of photoelectrodes, and particularly relate to photoelectrodes for solar water oxidation.

### BACKGROUND

The distinction between electricity and fuel use in analyses of global power consumption statistics highlights the importance of establishing efficient synthesis techniques for solar fuels; solar fuels are those chemicals whose bond energies are obtained through conversion processes driven by solar electromagnetic energy. Photoelectrochemical (PEC) processes show potential for the production of solar fuels because of their demonstrated versatility in facilitating optoelectronic and chemical conversion processes. Tandem PEC-photovoltaic modular configurations for the generation of hydrogen from water and sunlight (solar water splitting) provide an opportunity to develop a low-cost and efficient energy conversion scheme. The important component in devices of this type is the PEC photoelectrode, which needs to be optically absorptive, electrochemically stable, and possess the required electronic band alignment with the electrochemical scale for its charge carriers to have sufficient potential to drive the hydrogen and oxygen evolution reactions.

### SUMMARY

The systems, methods, and devices of this disclosure each have several innovative aspects, no single one of which is solely responsible for the desirable attributes disclosed herein.

In some embodiments, a device includes a substrate including an electrically conductive surface and a nanostructure in electrical contact with the electrically conductive surface. The nanostructure includes an impurity proximate a surface of the nanostructure, and the impurity is configured to allow the nanostructure to absorb light.

In some embodiments, the substrate includes a transparent material, and the electrically conductive surface includes a layer disposed on the transparent material. In some embodiments, the layer includes a material selected from the group consisting of SnO₂:F, In₂O₃:SnO₂, ZnO:Al, ZnO:Ga, CdO, CdO:In, and SnO₂:Sb. In some embodiments, a thickness of the layer is about 10 nanometers to 1 micron or about 100 nanometers to 800 nanometers.

In some embodiments, the nanostructure includes a wide-band gap semiconductor. In some embodiments, the wide-band gap semiconductor is selected from the group consisting of ZnO, TiO₂, WO₃, Ta₃O₅, Nb₂O₅, GaN, SrTiO₃, BaTiO₃, FeTiO₃, KTaO₃, SnO₂, Bi₂O₃, Fe₂O₃, Ga₂O₃, and BiVO₄. In some embodiments, the nanostructure comprises a structure selected from the group consisting of a nanorod, a nanoparticle, and a nanosheet.

In some embodiments, the impurity is configured to create energy levels that are within a band gap of the nanostructure. In some embodiments, the impurity is selected from the group consisting of Ni, Co, N, Mn, Fe, S, Se, C, B, Cr, and V. In some embodiments, the impurity is located about 2 nanometers to 200 nanometers beneath the surface of the nanostructure.

In some embodiments, an internal region of the nanostructure is electrically conductive.

In some embodiments, the nanostructure includes a second impurity, wherein an electronic state of the second impurity is configured to modify the electronic band structure of the nanostructure, and wherein the second impurity is located in an internal region of the nanostructure. In some embodiments, the second impurity is selected from the group consisting of Al, Ga, and Sb.

In some embodiments, the nanostructure includes at least type of one defect, and wherein defects are located in an internal region of the nanostructure. In some embodiments, the defects include oxygen vacancies.

In some embodiments, a method includes (a) depositing a nanostructure on a surface of a substrate, and (b) forming a first impurity in the nanostructure. The surface of the substrate is electrically conductive. The first impurity is configured to allow the nanostructure to absorb light.

In some embodiments, operation (a) includes a process selected from the group consisting of pulsed laser deposition, electrochemical deposition, chemical vapor deposition, sputtering, hydrothermal synthesis, chemical bath deposition, spray coating, spin coating, dip coating, electron-beam evaporation, and thermal evaporation.

In some embodiments, operation (b) includes at least one of diffusion of the first impurity into the nanostructure and implanting the first impurity into the nanostructure.

In some embodiments, operation (a) includes adding a second impurity to a deposition source used to deposit the nanostructure, and wherein an electronic state of the second impurity is configured to modify the electronic band structure of the nanostructure. In some embodiments, the second impurity is selected from the group consisting of Al, Ga, and Sb.

In some embodiments, the method further includes adding at least one type of defect in the nanostructure before operation (b). In some embodiments, the at least one type of defect includes oxygen vacancies, and the operation of adding the defects includes heating the nanostructure in an oxygen-deficient environment.

In some embodiments, the method further includes performing a thermal annealing treatment on the nanostructure after operation (a).

### BRIEF DESCRIPTION OF THE DRAWINGS

FIGS. 1-3 show examples of cross-sectional schematic illustrations of photoelectrodes.

FIG. 4 shows an example of a process for fabricating a photoelectrode.

### DETAILED DESCRIPTION

Photoelectrode structures capable of efficient conversion of light with visible frequencies, which is abundant in the solar spectrum, are needed for PEC photoelectrodes. Metal oxides represent one of the few material classes that can be made photoactive and remain stable to perform the required functions.

Disclosed herein are strategies to decouple the optical absorption and electronic transport processes required for operation of metal oxide photoelectrodes by spatially segregating the functional impurity concentrations that facilitate their associated physical processes.

One technique to sensitize metal oxides to visible light is to introduce dopants that are associated with visible-light-active electronic transitions. If dopant species are introduced in low concentration, below the substitutional limit in the host oxide lattice, optical spectroscopy measurements of films and particle suspensions (typical photoelectrode and photocatalyst configurations) commonly indicate weak shoulders associated with dopant-induced light absorption relative to the host's band-edge absorption. This observation relates to the comparably lower density of states of absorbing impurity levels within the host oxide band structure: because the solubilities of many dopants of interest are restricted to a few atomic percent, for nearly equivalent cross-sections, dopant-induced absorption is expected to be an inherently weaker process than absorption directly affected by the host oxide band structure. Heavily doping beyond the substitutional limit may assist further in sensitization, but with an associated sacrifice of crystallographic order in the surrounding lattice.

Consequently, in order to achieve optical thickness at these weakly absorbing wavelengths, the path length within the electrode structure needs to be increased, which for conventional film-based electrodes requires the fabrication of physically thick structures. The use of thick films, however, may be problematic because of the generally poor transport of carriers in metal oxides, and especially carriers associated with isolated impurity states. The disparity between absorption lengths and transports lengths in oxide materials of interest for this application is addressed generally in the growing literature dedicated to the use of nanotechnologies for solar PEC hydrogen generation.

Thus, doping traditional metal oxide photoelectrodes may present the situation where many free carriers generated by visible light excitations recombine before reaching the rear contact or reacting electrochemically at the oxide-liquid interface. Consequently, a viable strategy to enhance the conversion efficiencies of doped metal oxide-based photoelectrodes may be to decouple the optical absorption and electronic conduction processes that occur during their operation. In order to accomplish this, the electrode architecture needs to be designed such that the associated physical phenomena are segregated, while maintaining spatial register among the facilitating structure regions.

Embodiments disclosed herein provide a photoelectrode. In some embodiments, the photoelectrode includes an electrically conductive substrate and at least one nanostructure in electrical contact with the substrate, wherein the nanostructure includes an impurity or impurities in the near surface volume of the nanostructure, and wherein the impurity introduces a light-absorbing characteristic to the nanostructure. Embodiments disclosed herein also provide a method of fabricating a photoelectrode. In some embodiments, the method includes depositing at least one nanostructure on an electrically conductive substrate, resulting in the nanostructure being in electrical contact with the substrate and then introducing at least one impurity in the near surface volume of the nanostructure, where the impurity includes material that introduces a light-absorbing characteristic to the nano structure.

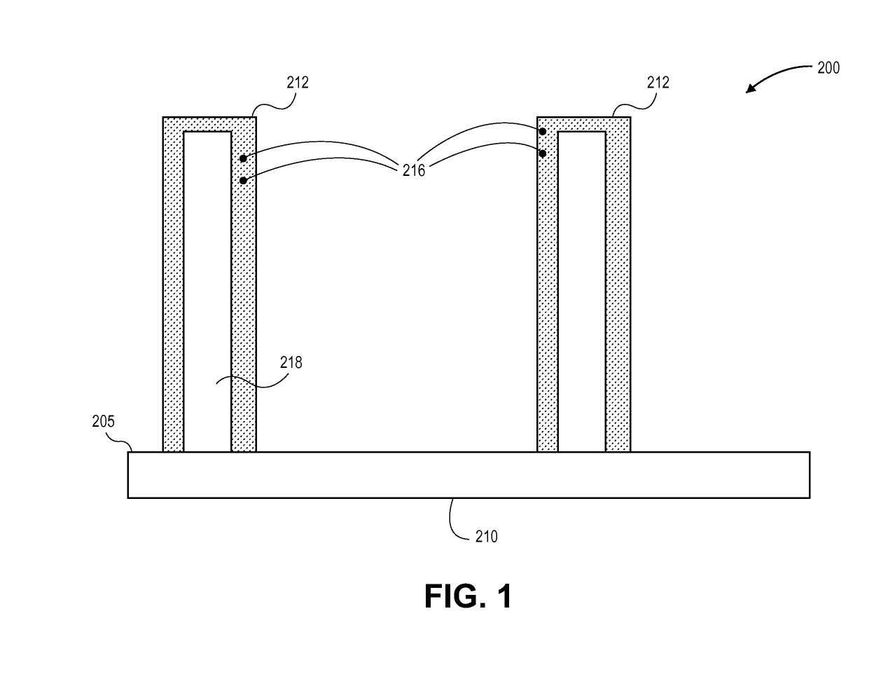

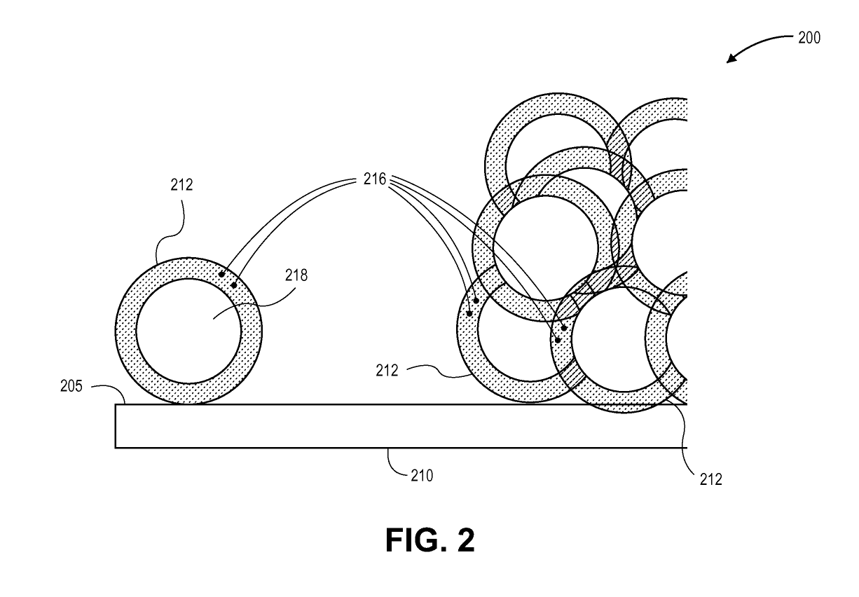

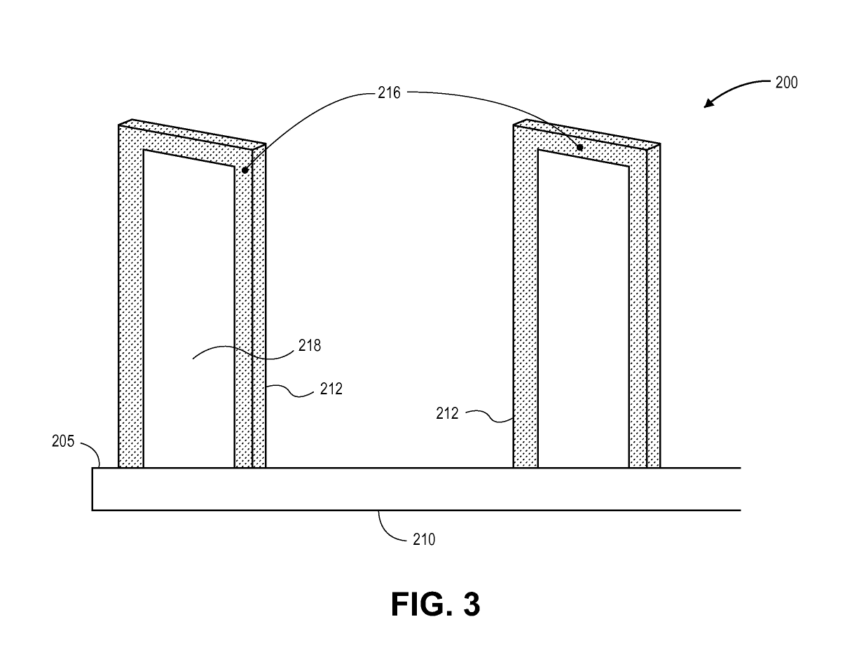

FIGS. 1-3 show examples of cross-sectional schematic illustrations of photoelectrodes. FIG. 1 shows an example of a photoelectrode including a nanorod. FIG. 2 shows an example of a photoelectrode including a nanoparticle. FIG. 3 shows an example of a photoelectrode including a high-aspect-ratio nanostructure.

As shown in FIGS. 1-3, a photoelectrode 200 includes a substrate 210 and a nanostructure or nanostructures 212 disposed on the substrate 210. The substrate includes a surface 205 that is electrically conductive, with the nanostructure 212 being disposed on the electrically conductive surface 205 of the substrate 210 and in electrical contact with the surface 205. The nanostructure 212 includes an impurity or impurities 216 proximate a surface of the nanostructure 212. The impurity 216 is configured to allow the nanostructure to absorb 212 light.

In some embodiments (e.g., as shown in FIG. 2), the impurities 216 are substantially proximate all surfaces of the nanostructures 212, including where the nanostructures 212 contact the surface 205. In some embodiments (e.g., as shown in FIGS. 1 and 3), the impurities 216 are not substantially proximate all surfaces of the nanostructures 212. In these embodiments, an internal region of the nanostructure may contact the surface 205.

In some embodiments, the substrate 210 includes a transparent material and a layer disposed on the transparent material, the layer forming the electrically conductive surface. In some embodiments, the transparent material is selected from the group consisting of glass, quartz, and polyethylene terephthalate. In some embodiments, the layer includes a material selected from the group consisting of SnO2:F, In2O3:SnO2, ZnO:Al, ZnO:Ga, CdO, CdO:In, and SnO2:Sb. In some embodiments, the thickness of the layer is about 10 nanometers to 1 micron thick, or about 100 nm to 800 nm thick.

In some embodiments, the nanostructure 212 includes a wide-band gap semiconductor. In some embodiments, the wide-band gap semiconductor is selected from the group consisting of ZnO, TiO2, WO3, Ta3O5, Nb2O5, GaN, SrTiO3, BaTiO3, FeTiO3, KTaO3, SnO2, Bi2O3, Fe2O3, Ga2O3, and BiVO4. In some embodiments, the wide-band gap semiconductor of each individual nanostructure is a single crystal. In some embodiments, the wide-band gap semiconductor of each individual nanostructure is polycrystalline.

As noted above, in some embodiments, the nanostructure 212 includes a nanorod (shown in FIG. 1), a nanoparticle (shown in FIG. 2), or a high-aspect-ratio nanostructure (shown in FIG. 3). In some embodiments, the high-aspect-ratio nanostructure includes a nanosheet. In some embodiments, the nanostructure 212 has physical dimensions and surface area that increases or maximizes light absorption by the nanostructure 212. In some embodiments, when the nanostructure 212 includes a nanorod or a high-aspect-ratio nanostructure, the nanostructure 212 is substantially normal to the substrate 210.

In some embodiments, the impurity 216 that imparts a light-absorbing characteristic to the nano structure 212 is an impurity that creates energy levels that are within the band gap of the nanostructure 212. In some embodiments, the impurity is selected from the group consisting of Ni, Co, N, Mn, Fe, S, Se, C, B, Cr, and V. The impurity 216 is proximate a surface of the nanostructure 212. For example, the impurity 216 may be located about 2 nm to 200 nm beneath the surface of the nanostructure 212.

In some embodiments, an internal region 218 of the nanostructure 212 is electrically conductive. For example, in some embodiments, the internal region 218 may be a region of the nanostructure 212 that do not include the impurity 216. While FIGS. 1-3 show a clear division between the internal region and an external region (i.e., a region proximate a surface of the nanostructure), this may not be the case. For example, there may be a gradual transition in the composition of the nanostructure from the internal region to the external region of the nanostructure.

In some embodiments, the internal region of the nanostructure 212 includes a second impurity, where the electronic state of the second impurity is a shallow donor in the band structure of nanostructure 212. In some embodiments, the internal region of the nanostructure 212 includes a second impurity, where the second impurity is configured to modify the electronic band structure of the nanostructure 212. In some embodiments, the second impurity is selected from the group consisting of Al, Ga, and Sb. In some embodiments, the second impurity renders the internal region of the nanostructure 212 electrically conductive.

In some embodiments, the internal region of the nanostructure 212 includes at least type of one defect. In some embodiments, the one type of defect includes oxygen vacancies. In some embodiments, the defects render the internal region of the nanostructure 212 electrically conductive.

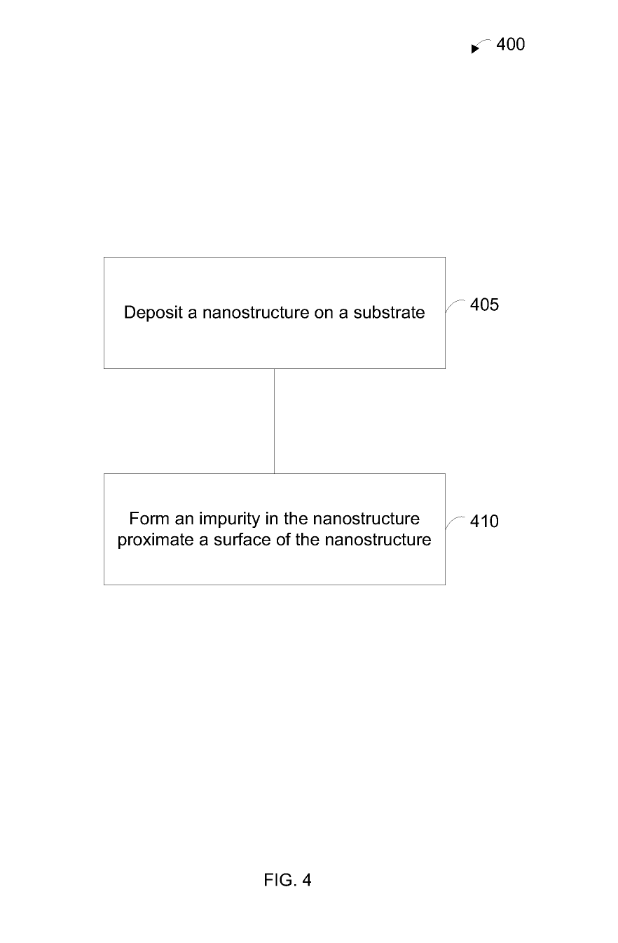

FIG. 4 shows an example of a process for fabricating a photoelectrode. The method 400 begins with operation 405 of depositing a nanostructure on a substrate. In some embodiments, the substrate is electrically conductive. In operation 410, an impurity is formed in the nanostructure proximate a surface of the nanostructure. In some embodiments, the impurity is configured to allow the nanostructure to absorb light. In some embodiments, the nanostructure is in electrical contact with the substrate.

In some embodiments, depositing the nanostructure in operation 405 includes pulsed laser deposition, electrochemical deposition, chemical vapor deposition, sputtering, hydrothermal synthesis, chemical bath deposition, spray coating, spin coating, dip coating, electron-beam evaporation, or thermal evaporation.

In some embodiments, operation 405 includes a process for rendering an internal region of the nanostructure electrically conductive. For example, in some embodiments, a second impurity may be included in a deposition source. When the nanostructure is deposited, the internal region of the nanostructure may include the second impurity. In some embodiments, the second impurity may be a shallow donor in the band structure of the nanostructure or modify the band structure of the nanostructure. For example, the second impurity may be Al, Ga, or Sb.

In some other embodiments, at least one type of defect may be added to the nanostructure to render the internal region of the nanostructure electrically conductive. For example, oxygen vacancies may be added to the internal region of the nanostructure. In some embodiments, oxygen vacancies may be added to the internal region of the nanostructure by heating the nanostructure in an oxygen-deficient atmosphere.

In some embodiments, the process 400 may include an operation of thermally annealing the nanostructures after operation 405. Thermally annealing the nanostructures may change the band structure of the nanostructures.

Operation 410 may include many different methods forming an impurity in the nanostructure proximate a surface of the nanostructure. For example, in some embodiments, an impurity may be diffused into nanostructure. To diffuse an impurity into the nanostructure, a material may first be deposited on the nanostructure using pulsed laser deposition, electrochemical deposition, chemical vapor deposition, sputtering, hydrothermal synthesis, chemical bath deposition, spray coating, spin coating, dip coating, electron-beam evaporation, or thermal evaporation, for example. Then, the nanostructure may be thermally annealed to diffuse the impurity into the nanostructure.

In the method 400 of fabricating a photoelectrode, in some embodiments, operation 405 may be performed and then operation 410 may be performed. In some embodiments, operation 410 may be performed and then operation 405 may be performed.

### Experimental Details

The technological implementation of weakly absorptive materials with poor charge transport properties has been addressed in the various designs for metal-oxide-containing excitonic photovoltaic devices. In these devices, organic dyes or semiconductor nanocrystals are intimately contacted with media whose operational purpose is to selectively accept (or separate) and transport photogenerated charges for collection in an external circuit. This configuration has also been applied toward the photoelectrochemical generation of hydrogen in electrolytes containing sacrificial reagents to considerable success. If the concept is applied toward the fabrication of metal oxide photoelectrodes for water splitting an analogy can be drawn between the sensitizer phase and a doped, visible-light-active oxide crystal, in that both of these materials are optically absorptive in the spectral range of interest but efficiently transport charges only over short physical distances. Deposition onto nanostructured substrates permits the use of absorber layers with small physical thickness but large optical thickness (as realized, for example, in extremely-thin-absorber photovoltaic cells and α-Fe₂O₃ photoanodes). If the substrate is of the same character as the sensitizer phase, the conceptual outcome of this application is a single-phase, oxide nanostructure that is inhomogeneously doped to perform the optoelectronic conversion processes relevant to the oxidation of water using solar energy. The isostructural nature of the absorbing and conducting regions in this case has the potential to yield low concentrations of interface recombination centers, which has significant consequences on the overall conversion efficiencies of PEC devices.

The concept was demonstrated with ZnO nanostructures doped in core regions with shallow Al donor levels for enhanced electronic conduction and in the near-surface volume with intragap Ni impurity states for increased optical absorption. However, the strategy is quite general and can be applied to numerous oxides and impurities; additional experiments were conducted with photoactive nitrogen impurities in place of nickel, with similar, albeit less-pronounced, PEC performance enhancements evident.

Substitutional Al is a shallow donor in the ZnO nanocrystal lattice and is associated with large increases electronic conductivity, which results from an order of magnitude increase in carrier concentration. The ionization energy of Al states has been measured to be approximately 90 meV. It is therefore identified as a suitable dopant to facilitate enhanced electronic transport to the rear contact during PEC operation.

Visible light sensitization on the other hand involves the introduction of impurity states deeper within the band gap of ZnO. Substitutional impurities on the cation site can be used to functionally sensitize ZnO crystals if they introduce impurity levels or bands that are situated at potentials meeting the thermodynamic requirement for water oxidation. The requirement is met by a number of transition metal impurities; the mechanism by which these impurities sensitize ZnO to visible wavelengths will be discussed below.

An X-ray diffraction pattern after fabrication indicated the presence of hexagonal ZnO and the tetragonal SnO₂ substrate. The ZnO was highly (002)-textured, which resulted from the c-axis alignment of nanostructures normal to the substrate. The small unlabeled peaks in the X-ray diffraction pattern around 26° and 56° were present in all ZnO samples regardless of dopant composition, and may be attributed to a contamination artifact from the fabrication procedure.

The optical absorptance spectra of ZnO nanostructure arrays deposited onto fluorine-doped tin oxide (FTO) substrates with and without the introduction of crystallites doped with Ni included absorption features beyond 400 nm associated with a change in sample color from transparent-white to green, which is consistent with previous studies. Comparison the optical absorptance spectra of a reference ZnO:Ni thin film, deposited under identical conditions directly onto the FTO substrate, highlights the increase in optical thickness at visible wavelengths that is associated with the nanostructured homojunction architecture.

The broad absorption features at long wavelengths overlapped with transitions associated with tetrahedrally coordinated Ni(II) in the ZnO lattice. Examination of the diffuse reflectance spectra for ZnO:Al and ZnO:Al—ZnO:Ni on FTO/glass substrates provided additional resolution for these transitions. The spectra indicated reflectance features at some wavelengths that were introduced along with Ni-doped ZnO crystallites, which suggest a tetrahedral coordination of Ni(II).

Photoelectrochemical characterization of the ZnO/FTO electrodes in aqueous 0.5 M Na₂SO₄ provided confirmation of the concept's successful application toward visible-light-driven solar water splitting. Current-potential curves indicated a monotonic photocurrent increase with applied anodic potential until the onset of dark current, which suggests effective charge separation at the semiconductor-liquid junction. Insertion of a UV filter in the optical path, which eliminates wavelengths below 410 nm, caused a moderate decrease in photocurrent response. The magnitude of the contribution of UV-driven photoactivity to total activity may be explained by the comparably small UV photon flux available in solar (simulated) light (˜5% of spectral intensity). Amperometric (current-time) measurements with application of color filters indicated the portion of total photocurrent driven by visible light. In these conditions approximately 44% of total photocurrent originated from wavelengths beyond 410 nm; 4.4% originated from beyond 510 nm. Similar analyses of ZnO electrodes without Ni indicate the photocurrent is almost completely UV-driven.

The incident photon conversion efficiency (IPCE) at visible wavelengths for front-side irradiation and with +1 V applied versus a Pt counter electrode was determined. There is a marked decrease (ca. 4 times) of UV photoactivity upon addition of ZnO:Ni species, which can be understood by observation that all photoholes originating from UV excitation must pass through impure visible-light-active crystals at the ZnO-water interface. Efficiency losses of this type can be minimized through the general improvement of electrode architecture, as discussed below.

To investigate the effect of the homojunction architecture on visible-light-driven water oxidation efficiency, the IPCE spectrum of a dense ZnO:Ni thin film deposited under identical conditions was compared to the nanostructured homojunction array. These data indicated that approximately a three-fold enhancement in conversion efficiencies for solar-abundant visible wavelengths was achieved by distributing the absorptive species normal to the substrate and along the direction of light propagation. It was determined that the design effectively shifts the spectral photocurrent response of ZnO electrodes toward lower energies abundant in the solar spectrum.

One study examined the spectral photocurrent contribution toward water oxidation of isovalent Mn²⁺, Co²⁺, and Ni²⁺ dopants in ZnO polycrystalline photoanodes. It was suggested that visible light photoactivity originated from d-d transitions within the dopant ion, with subsequent charge transfer into the ZnO band structure. In this interpretation, photoelectrons originating from impurity 3dⁿ excitations were transferred to the ZnO conduction band (Zn 4s⁰ orbitals); holes were transported to the ZnO-electrolyte interface in a defect band and were electrochemically active in a buffered Na₂SO₄ solution.

Another study unambiguously determined that charge transfer states are required to generate observable photocurrents associated with transition metal dopants in ZnO. Based on these previous analyses of ZnO:Co and ZnO:Ni, excitations with wavelengths near 430 nm can be assigned to an acceptor-type ionization, where an electron is promoted to the dopant d-shell orbitals from ZnO-based donor orbitals of the valence band. If the ZnO lattice is considered a ligand of the dopant ion, these transitions fit the general description of ligand-to-metal charge transfer transitions. The excited state of the charge transfer transition in this case is a valence band hole Coulombically bound to a Ni⁺ dopant ion. This can be deduced from the numerous previous analyses of isovalent transition metal dopants in ZnO and other II-VI semiconductor lattices.

References suggest the excitation can be described as:

Ni²⁺+hv→Ni⁺+h_{VB}⁺. Equation 1

The bound carrier generated from this excitation should possess a hydrogen-like wave function and a potentially large orbital radius, but one which is reduced relative to a free hole. In the context of this assignment, it is clear that the efficient utilization of valence band charge transfer transitions for solar water oxidation will require the use of thin doped regions that are located in close proximity to the electrolyte.

Based on these optical and photoelectrochemical data and the literature, some conclusions can be drawn regarding the electronic band structures of the inhomogeneously doped nanostructures. The band diagram reflects the theoretical understanding of photoanode operation established in the literature but is augmented by the literature-derived electronic states matching the profiles in the structures.

In order to investigate the nature of the observed efficiency enhancements at visible wavelengths, the internal quantum efficiency, or absorbed photon conversion efficiency, of the samples were calculated. These efficiencies were calculated through the following equations:

$$\begin{matrix}{T}_{measured} = {T}_{1} \times {T}_{2} \times … {T}_{n} & Equation 2 \\ {T}_{λ , film} = \frac{{T}_{λ , measured}}{{T}_{λ , substrate}} & Equation 3 \\ {A}_{λ} = ln ( {T}_{λ , film} ) & Equation 4 \\ {LHE}_{λ} = 1 - {e}^{{A}_{λ}} & Equation 5 \\ {APCE}_{λ} = \frac{{IPCE}_{λ}}{{LHE}_{λ}} & Equation 6\end{matrix}$$

where Tₙ is the transmittance of a component in the layered structure, T_{λ,film} is the transmittance of the film, corrected for the substrate as from equations 2 and 3, A_{λ} is the absorbance, LHE_{λ} is the light harvesting efficiency, and APCE_{λ} is the absorbed photon conversion efficiency. The magnitudes of the APCE values increase dramatically for wavelengths where there is little light absorption, which results in oscillations in the curves corresponding to those in the LHE spectra.

The curves indicate that both the LHE and APCE at visible wavelengths are increased by distributing ZnO:Ni vertically along the direction of light propagation. The variation in the APCE values over this spectral range may indicate differences in intrinsic escape probabilities for photogenerated electrons and holes. Longer wavelength excitations may correspond to alternative excitations, such as those related to metal-to-ligand charge transfer transitions, which have different branching ratios for charge separation in their excited states. The transitions could be sensitized by an optical absorption band near 2.9 eV, which would tend to flatten the IPCE curve relative to the APCE curve. The oscillations in APCE are present in both planar and distributed configurations, which suggests they are related to the electronic structure of the material itself. More in-depth analyses of the material's electronic structure would be required to elucidate the nature of these transitions.

This observation of enhanced LHE and APCE provides confirmation of the proposed benefits of the homojunction architecture discussed above: greater LHE suggests an enhancement in optical absorption and greater APCE at visible wavelengths suggests an enhancement in charge separation. Because the thickness of the photoactive layer is reduced by distributing species over a larger surface area substrate, the design facilitates shorter carrier transport path lengths to phases where carrier extraction occurs. This result may also suggest that electrons excited from charge transfer transitions within the ZnO band structure are more easily transferred to the ZnO:Al phase than to the SnO₂:F substrate.

In an ideal photoelectrode, the dopant profiles within the structures should be tailored to maximize conversion efficiency, which depends on, among other quantities, the free electron mobility and concentration, minority carrier (hole) transport length, and extinction coefficient. The metal oxide's feature dimensions should be constructed to maximize both the spectral overlap of optical absorption with the terrestrial solar flux and quantity of photogenerated minority carriers reaching the oxide-water interface.

As part of an initial effort toward design optimization, the optical functions of a ZnO:Ni thin film were approximated by a combined ellipsometry-reflectometry technique, the results of which are consistent with previous measurements of metal-doped ZnO films. These analyses accurately determined the complex refractive index and associated spectral absorption coefficient of the film. The light penetration depths determined by this spectral quantity suggest that the optimal structure dimension in the direction of light propagation is on the order of several micrometers, which could be reduced by accounting for the significant light scattering effects associated with irradiation of nanowire arrays.

Here again a close analogy can be drawn to the design of dye-sensitized solar cells, which require dye molecule adsorption over several micrometers of porous structure to achieve optical thickness. Careful analyses of SEM images indicate the absorptive crystallites are distributed for as long as 1.5 μm along the direction of light penetration. The demonstrated efficiency enhancement is conceptually similar to the dramatic enhancement evident in dye-sensitized solar cells when planar TiO₂ dye adsorption substrates are replaced with nanostructured TiO₂. It is suggested that an optimization route for fabrication of efficient homojunction nanostructures of this type is analogous to maximization of dye loading in dye-sensitized solar cells—optimization requires the select doping of the near-surface volume of porous nanostructures over several micrometers.

There is in fact an all (electro)chemical route to the fabrication of metal oxide homojunction nanostructure arrays of the type described above. Chemical growth of ZnO and TiO₂ structures with very large aspect ratios has been reported by various techniques. In addition, electrochemical deposition has successfully been employed in the literature to obtain conformal deposition of films into deeply-structured substrates. Doped metal oxide films are routinely fabricated by electrodeposition. A two-step (electro)chemical process is therefore proposed for the fabrication of high-aspect ratio metal oxide homojunction nanostructure arrays. Such a process is expected to accomplish fabrication at low temperatures, which suggests compatibility with low-cost and flexible substrates. Additional future work includes the in-depth analysis of the long-term stability of the dopants and their concentration profiles under operating conditions, a theoretical prediction of the optimal electrode three-dimensional geometry based on known material properties, as well as an analysis of optimal material systems suitable for this technique.

This disclosure introduced and experimentally verified the conceptual framework for the design of solar water oxidation photoelectrodes based on the spatially inhomogeneous doping of metal oxide nanostructures. Optical absorption and electronic conduction can be decoupled and optimized by spatially segregating the functional impurity species that facilitate their associated physical processes. The nanostructure regions possess functional specificity that is established by their chemical composition and three-dimensional geometry, which includes volume, orientation with respect to the direction of light propagation, as well as proximity to the semiconductor-liquid interface. Experimental results indicate optical absorption at visible wavelengths and the related water oxidation conversion efficiencies can be enhanced by physically distributing absorbing crystallites along the direction of light propagation while maintaining their close proximity to the oxide-water interface. An optimization pathway based on these results, analogous to the well-known optimization procedures for excitonic photovoltaic devices, has been suggested.

### Supplemental Experimental Details

The nanostructures were fabricated through a combination of electrochemical deposition and physical vapor deposition. Physical, optical, and photoelectrochemical characterization were performed by standard techniques.

Al-doped ZnO nanorod arrays were fabricated by electrochemical deposition in a three-electrode cell employing a Pt wire counter electrode, silver/silver chloride (Ag/AgCl) reference electrode (in 4 M KCl, separated from the electrolyte by a porous frit), and fluorine-doped tin oxide (FTO) working electrode contacted to a Cu wire with conductive Ag paste. Before deposition, FTO/glass substrates were sequentially sonicated in acetone, ethanol, and water for 15 minutes each. Deposition occurred for 0.5 to 1 hr at 90° C. and at −0.9 V vs. Ag/AgCl in an aqueous (18.1 MΩ-cm water) electrolyte containing 1-6 mM zinc nitrate hexahydrate (Zn(NO₃).6H₂O; 98%) and methenamine (C₆H₁₂N₄) as described in the literature, and 1-5 μM aluminum chloride (AlCl₃; 99.999%).

The arrays were modified by species generated from the pulsed laser ablation of pressed polycrystalline targets in O₂ and N₂ ambients. ZnO and NiO targets were selectively ablated in the presence of oxygen (or mixture of oxygen and nitrogen for ZnO:N deposition) and species from the resulting plasma were deposited onto the ZnO:Al/FTO samples as prepared by electrochemical deposition. The pressure during deposition was 3 to 5 mtorr as measured by a pirani pressure gauge mounted on the chamber. The samples were maintained at 200° C., using a resistive heater and a thermocouple probe embedded in the substrate holder. The laser fluence at the target surface (pulse energy, spot size) and target-substrate distance were selected such that a uniform film could be deposited over several square centimeters.

Scanning electron microscopy (SEM) images were obtained with an environmental field emission scanning electron microscope operating in secondary electron detection mode.

Spectral transmittance and diffuse reflectance measurements were taken on the ZnO/FTO/glass samples with a spectrophotometer fitted with an integrating sphere at a wavelength interval of 2 nm. The sample was irradiated at the front surface. The spectral absorptance was obtained by solution of the equation A_{λ}=100−R_{λ}−T_{λ}, and no correction was made for the substrate.

X-ray diffraction (XRD) measurements were performed on a diffractometer with Cu Kα radiation.

All electrolytes were prepared with 18.1 MΩ-cm water. The electrolyte for all PEC measurements was prepared as 0.5 M sodium sulfate (Na₂SO₄; >99% ACS grade; pH≈6.8).

Photoelectrochemical measurements were acquired in an open Pyrex cell fitted with a quartz window. A 1 cm² masked-off, sealed area of the sample was irradiated with a 300 W Xe lamp solar simulator with adjustable power settings through an AM 1.5 G filter. The light intensity at the sample location in the photoelectrochemical cell was 100 mW cm⁻² as measured by a power detector. No correction was made for the optical absorption of the ˜4 cm of electrolyte between the quartz window and sample location. A potentiostat was used to measure electrochemical data in a 3-electrode setup using a Ag/AgCl reference electrode and a coiled Pt wire counter electrode. The reversible hydrogen electrode (RHE) potential was calculated as E_{RHE}=E_{Ag/AgCl}+0.1976+0.057·pH. N₂ gas was continuously bubbled in solution and directly over the Pt counter electrode before and during the experiment to remove any dissolved O₂ and therefore suppress the reduction of O₂ at the counter electrode. For current-potential measurements, the potential scan was anodic (in the positive direction) and at a rate of 5 mV/s, with the light mechanically chopped at 0.2 Hz. For the UV filters employed, the transmission of light below the cut-off is below ˜1%; ˜10% of intensity is absorbed for wavelengths above the cut-offs.

For IPCE measurements, +1 V was applied versus a Pt foil located 1 cm from the irradiated portion of the sample. No correction was made for ohmic losses in the electrolyte. N₂ was bubbled in solution before measurements but experimental constraints did not permit bubbling during measurement. IPCE measurements were obtained on a quantum efficiency measurement system employing a Xe lamp, monochromator (5 nm FWHM, 10 nm interval), and light chopper (5 Hz), with a portion of the beam diverted to a photodiode. Averages of 6 measurements of 5 second sampling periods per wavelength were made. The system was calibrated before measurement using a NIST-calibrated Si photodiode.

The optical functions of the ZnO:Ni discussed above were approximated by a combined ellipsometry-reflectometry technique performed with a commercial thin film metrology system. During deposition of ZnO:Ni, a small (001) Si substrate was mounted approximately 1 cm from the area later probed by photoelectrochemical (PEC) measurements. The ellipsometric parameters psi and delta were measured on this sample at 70° incidence and over the wavelength range 350-1050 nm at 0.25 nm intervals. The specular reflection spectrum was recorded at 0° (normal) incidence over the range 280 nm to 1050 nm at 0.25 nm intervals.

A modified Tauc-Lorentz relation was used over the entire wavelength range to model the optical functions of the ZnO/Si structure. The dispersion relation forces the extinction coefficient k(E) to be zero at photon energies less than the optical gap and permits a reduction in k(E) as E→∞. However, the parameterization only describes interband transitions and cannot resolve Urbach tails or isolated defect transitions associated with impurity levels. Strictly speaking the dielectric function of ZnO has differing extraordinary and ordinary components. As a first approximation, this analysis assumes the optical properties are isotropic and produces effective optical functions. This technique has been previously applied to similar material systems.

The Bruggeman EMA relation was used to model the surface region with mixed dielectric functions. A surface roughness layer was modeled as a 50%-50% mixture of the ZnO layer and void space (air). The native oxide layer on the Si substrate was modeled using the Cauchy relations with literature values included in the software package. The structure used for simulation with labeled thicknesses was determined by regression analysis. A scanning electron microscopy (SEM) image of the ZnO/Si structure's cross section was consistent with the proposed model.

The simultaneous fitting of polarization-dependent reflections at two angles is expected to provide a high degree of accuracy for determination of thicknesses and complex refractive indices of multi-layer structures, and the combined technique assists in avoidance of multiple solutions. The measurement simultaneously probes intensity (reflectometry) and polarization changes (ellipsometry) in reflected light.

The analysis resulted in a close correlation among experimental and simulated values, yielding a correlation coefficient of R²=0.9996. Attempts to add additional physical accuracy through the introduction of additional oscillators and inter-mixing among layers resulted in unacceptable standard errors associated with their fitting.

A color-filtered amperometric (current-time) measurement was performed on ZnO:Al without modification with Ni. As expected, the photocurrent is primarily driven by UV excitation, which is only present under full spectrum irradiation. Application of color filters reduces total photoactivity significantly, consistent with IPCE results.

Further details regarding the subject matter disclosed herein can be found in the publication Coleman X. Kronawitter, Zhixun Ma, Dongfang Liu, Samuel S. Mao, and Bonnie R. Antoun, “Engineering Impurity Distributions in Photoelectrodes for Solar Water Oxidation,” Advanced Energy Materials, Volume 2, Issue 1, pages 52-57, January, 2012, which is herein incorporated by reference.

It is to be understood that the above description and examples are intended to be illustrative and not restrictive. Many embodiments will be apparent to those of ordinary skill in the art upon reading the above description and examples. The scope of the disclosed embodiments should, therefore, be determined not with reference to the above description and examples, but should instead be determined with reference to the appended claims, along with the full scope of equivalents to which such claims are entitled.

What is claimed is:

1. A device comprising:
a substrate including an electrically conductive surface; and
a nanostructure in electrical contact with the electrically conductive surface, wherein the nanostructure includes an impurity proximate a surface of the nanostructure, wherein the impurity is configured to allow the nanostructure to absorb light.

2. The device of claim 1, wherein the substrate comprises a transparent material, and wherein the electrically conductive surface includes a layer disposed on the transparent material.

3. The device of claim 2, wherein the layer comprises a material selected from the group consisting of SnO₂:F, In₂O₃:SnO₂, ZnO:Al, ZnO:Ga, CdO, CdO:In, and SnO₂:Sb.

4. The device of claim 2, wherein a thickness of the layer is about 100 nanometers to 800 nanometers.

5. The device of claim 1, wherein the nanostructure comprises a wide-band gap semiconductor.

6. The device of claim 5, wherein the wide-band gap semiconductor is selected from the group consisting of ZnO, TiO₂, WO₃, Ta₃O₅, Nb₂O₅, GaN, SrTiO₃, BaTiO₃, FeTiO₃, KTaO₃, SnO₂, Bi₂O₃, Fe₂O₃, Ga₂O₃, and BiVO₄.

7. The device of claim 1, wherein the nanostructure comprises a structure selected from the group consisting of a nanorod, a nanoparticle, and a nanosheet.

8. The device of claim 1, wherein the impurity is configured to create energy levels that are within a band gap of the nanostructure.

9. The device of claim 1, wherein the impurity is selected from the group consisting of Ni, Co, N, Mn, Fe, S, Se, C, B, Cr, and V.

10. The device of claim 1, wherein the impurity is located about 2 nanometers to 200 nanometers beneath the surface of the nanostructure.

11. The device of claim 1, wherein an internal region of the nanostructure is electrically conductive.

12. The device of claim 1, wherein the nanostructure includes a second impurity, wherein an electronic state of the second impurity is configured to modify the electronic band structure of the nanostructure, and wherein the second impurity is located in an internal region of the nanostructure.

13. The device of claim 12, wherein the second impurity is selected from the group consisting of Al, Ga, and Sb.

14. The device of claim 1, wherein the nanostructure includes at least one type of defect, and wherein defects are located in an internal region of the nanostructure.

15. The device of claim 14, wherein the defects include oxygen vacancies.

16. A method comprising:
(a) depositing a nanostructure on a surface of a substrate, the surface being electrically conductive; and
(b) forming a first impurity in the nanostructure, wherein the first impurity is configured to allow the nanostructure to absorb light.

17. The method of claim 16, wherein operation (a) includes a process selected from the group consisting of pulsed laser deposition, electrochemical deposition, chemical vapor deposition, sputtering, hydrothermal synthesis, chemical bath deposition, spray coating, spin coating, dip coating, electron-beam evaporation, and thermal evaporation.

18. The method of claim 16, wherein operation (b) includes at least one of diffusion of the first impurity into the nanostructure and implanting the first impurity into the nanostructure.

20. The method of claim 16, wherein in operation (a) includes adding a second impurity to a deposition source used to deposit the nanostructure, and wherein an electronic state of the second impurity is configured to modify the electronic band structure of the nanostructure.
